(19) United States
(12) Patent Application Publication
(10) Pub. No.: US 2010/0057781 A1
(43) Pub. Date: Mar. 4, 2010

(54) MEDIA IDENTIFICATION SYSTEM AND METHOD

(75) Inventor: Luis Stohr, Los Angeles, CA (US)

Correspondence Address: Alpine Electronics of America, Inc., 19145 Gramercy Pl., Torrance, CA, 90503, US

(73) Assignee: Alpine Electronics, Inc., Torrance, CA (US)

(21) Appl. No.: 12/547,646

(22) Filed: Aug. 26, 2009

Related U.S. Application Data
(60) Provisional application No. 61/190,287, filed on Aug. 27, 2008.

(51) Int. Cl. G06F 17/00; G06F 15/16

(52) U.S. Cl. 707/104.1; 709/203; 707/E17.032; 707/E17.009

(57) ABSTRACT

The present invention relates to a media identification system and method. The system and method includes a media source, a signal controlling device, a communication device, a server and a user interface. The media source can be in various formats, such as audio, video and still frame. A medium signal is converted and processed in the signal controlling device to generate a server-recognizable code, which can be transmitted to the server through the communication device. The communication device can be a mobile phone, or other communication devices adapted to relay signals. A “short-long” range signal transmission is also disclosed in the present invention, wherein the “short range” signal transmission between the signal controlling device and the communication device may be achieved by a wireless radio or optical transmission-reception technology such as Bluetooth, while the “long range” signal transmission between the communication device and the server may be achieved by WiFi or regular mobile phone transmission. Upon receiving the server-recognizable code, the server can analyze and search for candidate matches in the database. Once the server identifies the media, the media identification information can be transmitted back to from the server and displayed on the user interface.

### CROSS-REFERENCE TO RELATED APPLICATIONS

This application claims priority under 35 USC §119 (e) to U.S. Provisional Patent Application Ser. No. 61/190,287, filed on Aug. 27, 2008, the entire contents of which are hereby incorporated by reference.

### FIELD OF THE INVENTION

This invention relates to a media identification system and method. Particularly, this invention relates to a media identification system and method which can identify various types of media and provide media identification information to a user in a short period of time.

### BACKGROUND OF THE INVENTION

Music plays an important role in human history, and the demands for music quality and accessibility never cease. That is why music players evolve so quickly from bulky recorder players and tape players, to small walkmans and CD players, and further to stylish and tiny MP3 players, which have become the most popular consumer electronic devices in recent years.

Furthermore, due to digitalization of music files and advances of computer technologies, modern music players, such as iPod, can store hundreds of songs in a tiny device. Digitalized music files also facilitate distribution through the internet. Under these favorable circumstances, the music industry becomes one of the prosperous industries and nurtures the creation of music in great diversity.

When a person hears a song that he/she is unfamiliar with and if he/she likes it, he may want to know more information about the song before he/she makes the decision to purchase it. This usually happens when the person is driving and listening to the radio in the car, or at any other place where the person might hear music. The person may feel disappointed if the information is not available within a short period of time, and may forget about having heard of this song. In the recording or music industries, this may represent lost sales to a potential purchaser.

To solve this problem, some cellular phone companies provide music identification services. Typically, the service enables the user to record a portion of the music into the mobile phone and transmit the sample music to a server to identify the music, and the user will receive the music information from the server through text messages (SMS) displayed on the mobile phone.

However, the mobile phone may not be the best device to provide music identification services. The mobile phone reception may be weak in some places and if the music is played in an area of weak reception, the quality of music identification would be adversely affected. Also, if the user would like to know the information of a number of songs simultaneously, the mobile phone may not be able to record them all due to limited storage capacity. Furthermore, the airtime of the mobile phone is usually expensive and it is not practical if the user needs to record a number of music samples into the mobile phone.

U.S. Pat. App. Pub. No. 2006/0235864 discloses an audio sampling and acquisition system to facilitate purchase of media items as illustrated in FIG. 1. More specifically, the portable media device 125 is adapted to record an audio source 121 using a microphone 127 coupled to the portable media device 125, and the audio sample is transmitted, either directly or through a client device 104, to a media identification server 114 to retrieve the audio sample's identification. Such identification information will be transmitted back to the user. However, as mentioned above, if the user would like to know the information of a number of songs simultaneously, the portable media device 125 may not be able to record them all due to limited storage capacity. In addition, simultaneously transmitting a number of music samples to the data network may slow down the transmission process due to the size of massive music files.

Another method has been developed for music identification without recording and transmitting music samples. The method may include a small appliance adapted to communicate between the user and a web server. When the user wants to know the information of a song played in a radio station, the user may have to know some background information, such as the location of the user, the time when he heard the song, and the identity of the radio station, and transmits the information to the web server from the small appliance. The web server then compares the playlists of the subscribed radio stations with the information provided by the user to identify the song and transmits the music information back to the user. For example, as can be seen in FIGS. 2 and 2a, U.S. Pat. No. 6,941,275 to Swierczek discloses a music identification and purchasing system, specifically to a method for marking the time and the name of the radio station in portable device such as a key holder, watch, cellular phone, beeper or the like which will allow the user to learn via internet or regular telephone the name of the song, artist and/or music company by matching the stored data with broadcast archive.

Although this method does not involve music recording and transmission, the user has to remember the identity of the radio station and when the song was played. Also, the radio station playing the song has to be one of the subscribers to the web server. Finally, this method can only be applied to identify music played on the radio.

U.S. Pat. No. 6,995,309 to Samadani et al. discloses a system and method that allows users to find a song name, artist and performance without having to proceed through many false results. More particularly, as shown in FIG. 3, the system and method for identifying music comprising recording a sample of audio data and deriving a sample time signal from the audio data. A plurality of songs represented by time signals is sorted and the sample time signal is matched with the time signal of a song in the plurality of songs. However, as stated above, a capture device 305 may not be able to record as many songs as a user wants due to limited storage capacity. In addition, simultaneously transmitting a number of music samples to a network 322 may slow down the transmission process due to the size of massive music files.

Therefore, there remains a need for an improved system and method to provide media identification services that can overcome the limitations and undesirable aspects as stated above.

### SUMMARY OF THE INVENTION

It is an object of the present invention to provide a real-time media identification system and method, wherein media signals are transmitted to a signal controlling device where the media signals are further processed and wirelessly transmitted to a communication device through a short range engine in the signal controlling device, the communication device is adapted to transmit the processed server-recognizable signal to a server for media identification, and the server is configured to provide media identification and transmit such information back to a display unit via the communication device.

It is another object of the present invention to provide a media identification system and method to continuously generate and process media signals from a media source.

It is still another object of the present invention to provide a media identification system and method to identify various types of media, such as audio, video, and still-frame formats.

It is a further object of the present invention to provide a media identification system and method to provide the user a seamless platform for the user to obtain media information.

The present invention relates to a media identification system and method. The media identification system may include a media source; a signal controlling device; a communication device; a server and a display unit, wherein the signal controlling device receives media signals from the media source and generates server-recognizable signals which are subsequently transmitted to the communication device, then to the server is adapted to analyze and identify the server-recognizable signals, and transmit such information to the display unit.

The media source in the present invention can be, but not limited to music, movies or audio books. Music or audio books can be played on radio stations, cassettes, CD or MP3 players. Movies can be played by, for example, DVD players. The media signal in the present invention can be either analog or digital.

The signal controlling device may include an analog-to-digital converter (ADC), a digital signal processing (DSP) unit, a dialing unit, and a short range engine. The media signals from the media source may be processed in the ADC and the DSP unit to generate the server-recognizable signal, which can be wirelessly transmitted to the communication device through a short range engine in the signal controlling device. In one embodiment, the media may be further processed into a server-recognizable signal before transmitting to the server. In another embodiment, the communication device can be a mobile phone or any device which can relay signals from the signal controlling device to the server. In the present invention, a “short-long” range signal transmission is disclosed, wherein the processed signal is wirelessly transmitted to a mobile phone by using, for example, Bluetooth technology (short range), and then sent to the server by WiFi or any other mobile transmission (long range). In other embodiments, the processed signal may be transmitted to the server directly without the aid of the communication device.

Since more and more states in the United States prohibit drivers from using a handheld wireless telephone while driving, it may be unlawful for the driver who wants to get media information to operate the mobile phone to either record the sample music or communicate with the web server. By using the media identification system disclosed in the present invention, the driver may receive media information within a couple minutes by simply pushing one button on the head unit in the vehicle. In other words, the present invention actually provides an easy, convenient and “hands-free” platform for the user to obtain media information.

The server in the present invention refers to a media database including various formats of media, such as audio, video, and still-frame. When the server receives and recognizes the processed signal from the communication device, the server analyzes and matches the processed signal with a plurality of reference media signals stored in the database to provide media identification information. If the media is music, the media information may include the artist's name, the title of the music, and the name of the album. In one embodiment, the media information may be transmitted and displayed on the communication device, such as the cellular phone. In other embodiments, the media information may be displayed on a display unit.

In an exemplary embodiment, the media identification system may identify unfamiliar songs from radio programs. In another embodiment, the identification system may identify a number of unfamiliar songs simultaneously, e.g. from an unknown album. In still another embodiment, the identification system may identify an unknown movie from a DVD by analyzing and matching some unique information about the movie to search possibly matching records in the remote database if the records are available.

In one aspect, this identification system can be incorporated into a navigation system in a vehicle. In another aspect, this identification system can be incorporated into a home entertainment system.

In one exemplary embodiment, the signal controlling device may simply record the sound of the music, or some conversation of the movie, from the media source. The recorded media signal is then processed, transmitted and identified in the same manner as illustrated above.

In another aspect, the present invention also provides a method for media identification, which may include the steps of: receiving one or more media signals from a media source; identifying the media signals; requesting identification information from a server if at least one the medium signal is not identified, even when other medium is played; and transmitting the medium identification information to a memory unit and displaying such information on a display unit when the medium is played.

In the method of the present invention, the step of requesting identification information of the medium from a server includes the steps of continuously processing the medium signal and generating a server-recognizable code for each unidentified medium; transmitting each server-recognizable code to the server; and identifying each server-recognizable code in the server to obtain the medium identification information.

In the method of the present invention, the step of generating a server-recognizable code for each unidentified medium may include the step of processing the medium signal in an analog-to-digital converter (ADC) and a digital signal processing (DSP) unit. The step of transmitting the server-recognizable code to the server may include a step of transmitting the server-recognizable code to a communication device which is adapted to transmit the server-recognizable code to the server. The step of identifying the server-recognizable code in the server to obtain media identification information may include a step of analyzing and matching the server-recognizable code with a plurality of reference media codes stored in the server.

The present invention together with the above and other advantages may best be understood from the following detailed description of the embodiments of the invention illustrated in the drawings below.

### BRIEF DESCRIPTION OF THE DRAWINGS

FIG. 1 illustrates a prior art, related to a portable media device to record an audio sample using a microphone coupled to the portable media device, and the audio sample is transmitted, either directly or through a client device, to a media identification server to retrieve the audio sample's identification.

FIG. 2 illustrates a prior art, related to a music identification and purchasing system, specifically to a method for marking the time and the name of the radio station in portable device, which will allow the user to learn via internet or regular telephone the name of the song, artist and/or music company by matching the stored data with broadcast archive.

FIG. 3 illustrates a prior art, related to a system and method that allows users to find a song name, artist and performance without having to proceed through many false results.

FIGS. 4 and 4a illustrates one embodiment of the media identification system disclosed in the present invention.

FIG. 5 is a block diagram illustrating the internal architecture of the signal controlling device in FIG. 4.

FIG. 6 illustrates one aspect of the present invention, depicting a method for providing media identification information.

FIG. 6a illustrates one embodiment of the method for identifying media shown in FIG. 6.

FIG. 6b illustrates another embodiment of the method for identifying media shown in FIG. 6a.

FIG. 6c illustrates a further embodiment of the method for identifying media shown in FIG. 6a.

FIG. 7 illustrates another embodiment of the media identification system disclosed in the present invention.

FIG. 8 is a block diagram illustrating the internal architecture of the device in FIG. 7.

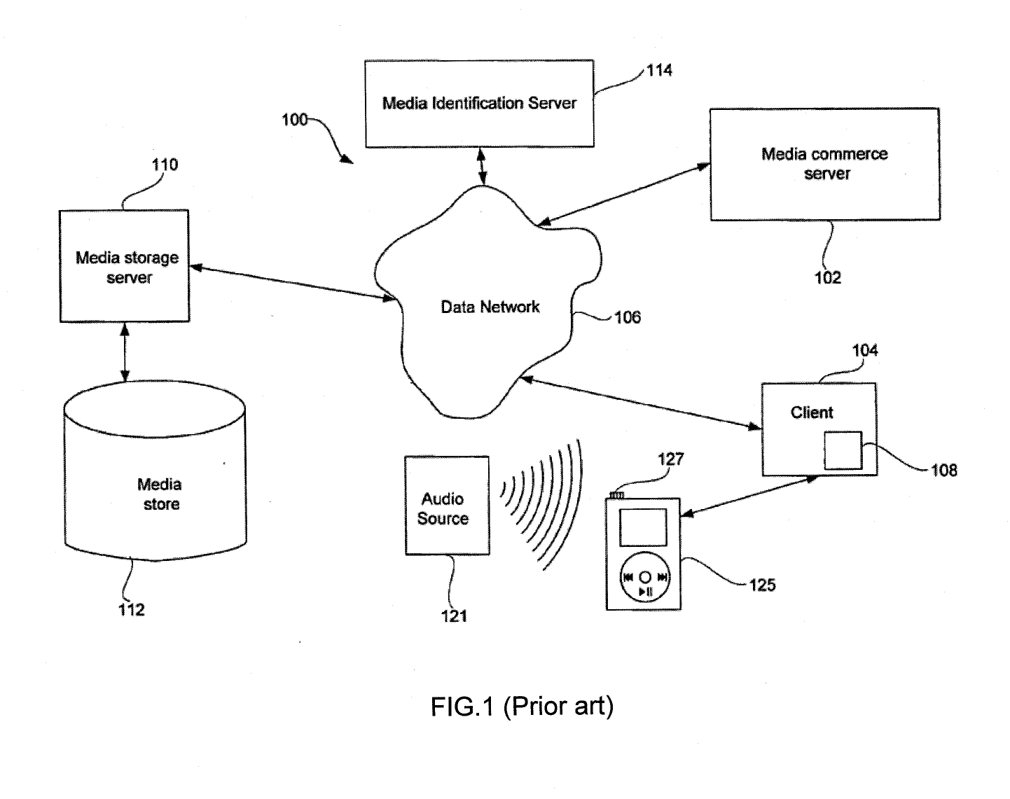

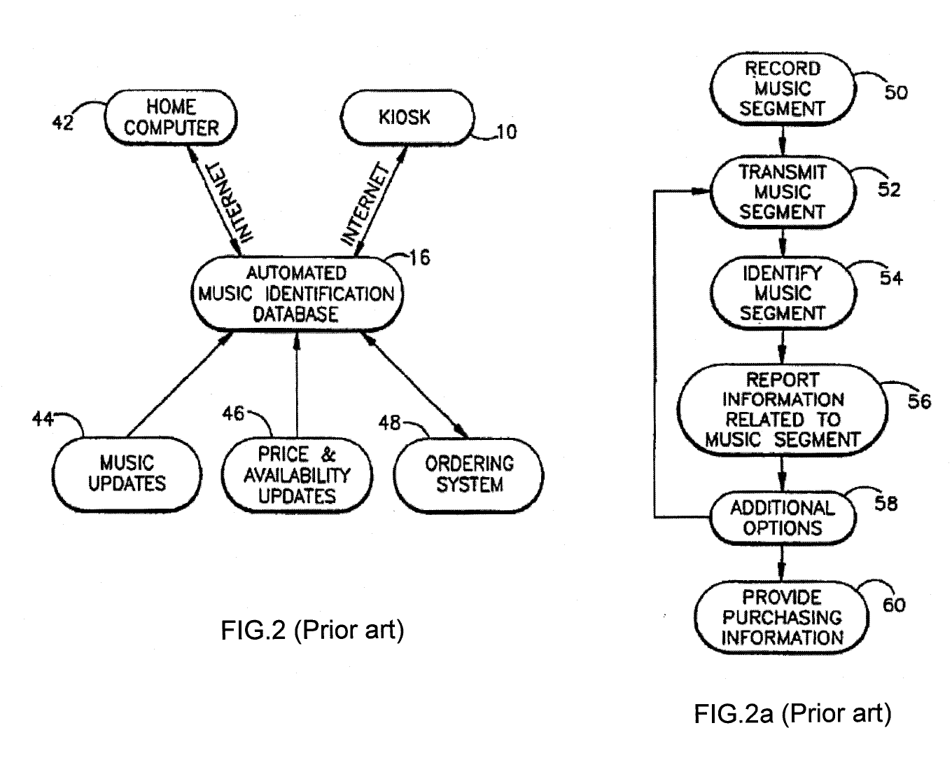

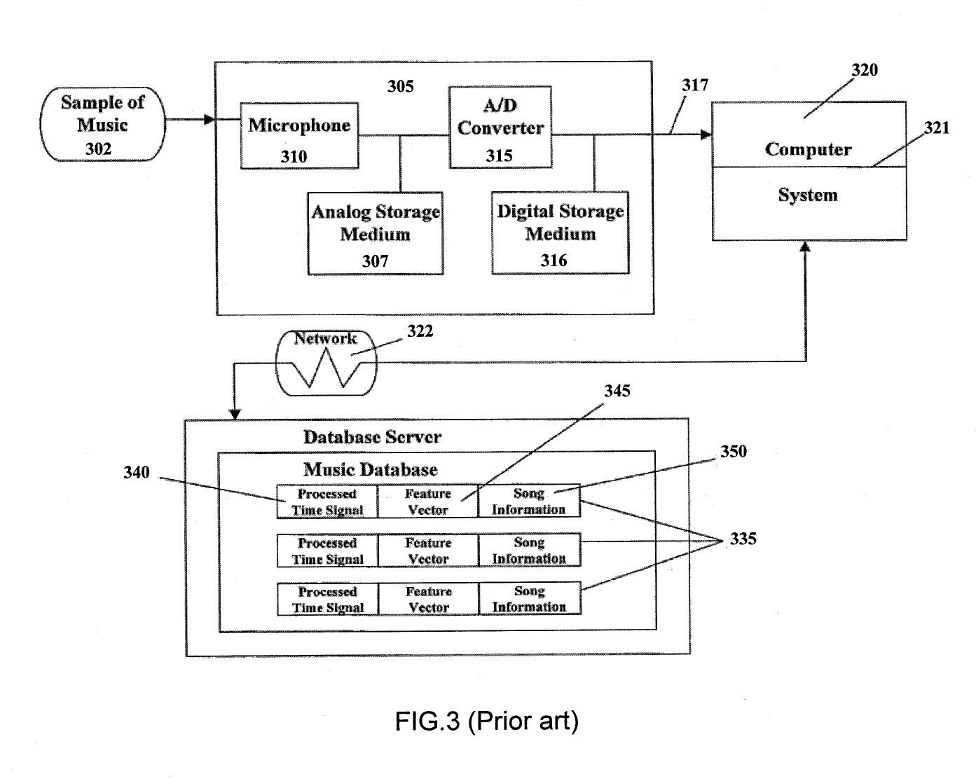

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

A system and method for media identification is disclosed. The present invention has applications in various formats of media, including audio, video, still-frame, etc. In an exemplary embodiment, the media identification system in the present invention can identify a song unknown to the user by analyzing a server-recognizable signal and searching the database in the server for candidate matches. Moreover, instead of recording and transmitting some portions of the music as described in the prior arts, the system in the present invention can handle a plurality of music segments simultaneously without using a lot of memory spaces by converting the music segments into music signals, which can be continuously transmitted to a server.

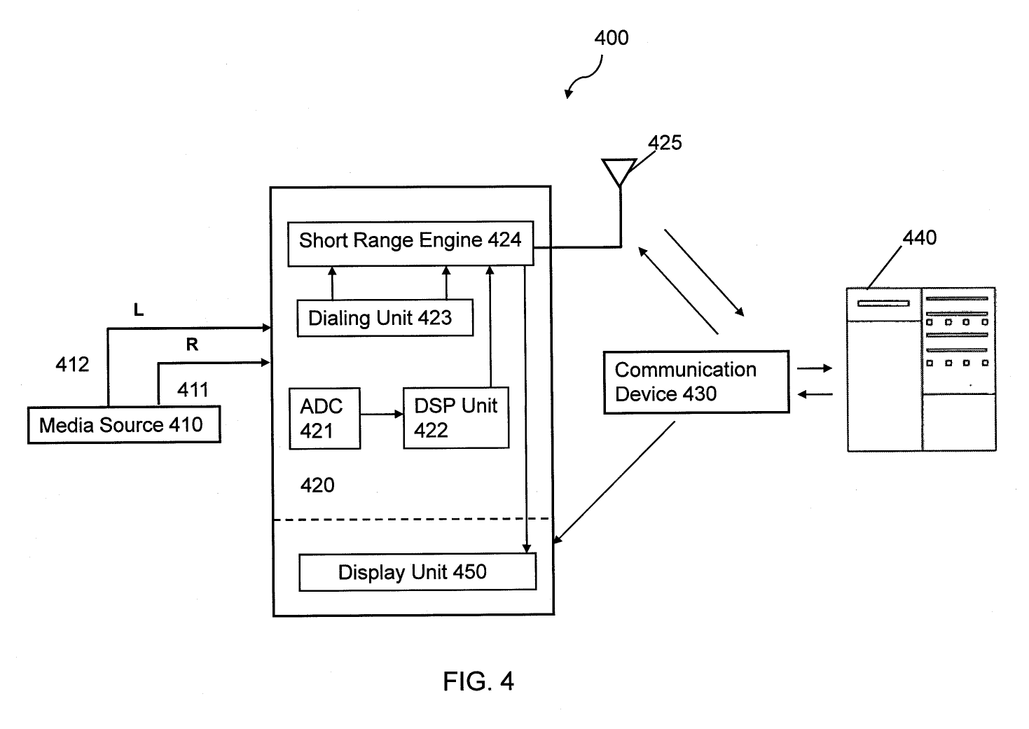

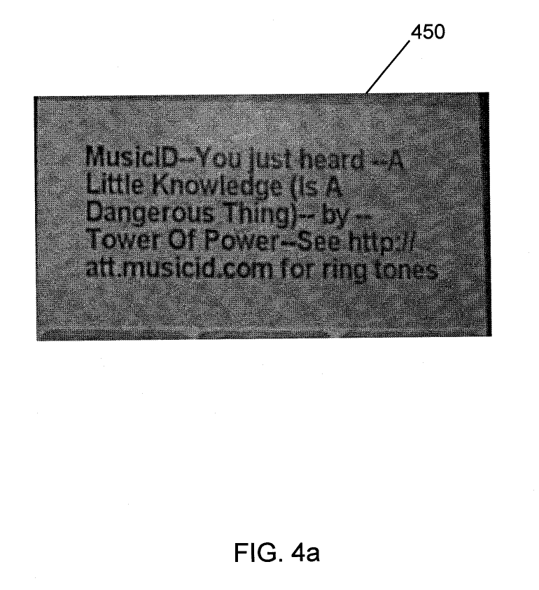

According to one aspect illustrated in FIG. 4, a media identification system 400 includes a media source 410, a signal controlling device 420, a communication device 430, a server 440 and a display unit 450. As stated above, the media source 410 can be in audio, video, or still-frame format. Audio files, such as music or audio books, for example, can be played on radio stations, cassettes, CD or MP3 players. In one embodiment, the identification system 400 can be incorporated to a navigation system in a vehicle. In another embodiment, the identification system 400 can be incorporated into a home entertainment system.

Still referring to FIG. 4, a medium signal is sent out through a right channel 411 and a left channel 412 to the signal controlling device 420 where the medium signal is further processed by an encoder that matches a server decoder before transmitting to the server 440. In one embodiment, the medium signal is digital. In another embodiment, the medium signal is analog. The analog signal may be converted to digital signal by an analog-to-digital converter (ADC) 421, and further processed by a digital signal processing (DSP) unit 422 to generate a server-recognizable code. A dialing unit 423 is communicatively coupled with a short range engine 424 to communicate with the communication device 430 and transmit the server-recognizable code out through an antenna 425.

The communication device 430 in the present invention is provided to receive the server-recognizable code from the signal controlling device 420 and send such code to the server 440. In other words, the communication device 430 acts as a bridge to facilitate signal communication between the signal controlling device 420 and the server 440.

In one embodiment, the communication device 430 can be a mobile phone. In another embodiment, the communication device 430 can be any other devices adapted to receive and transmit signals. In other embodiments, the server-recognizable code can be directly transmitted from the signal controlling device 420 to the server 440 without using the communication device 430.

A flexible “short-long” range signal transmission scheme is illustrated in the present invention. For example, the “short range” signal transmission can be achieved between the signal controlling device 420 and the communication device 430 by using radio or optical transmission technology such as Bluetooth, while the “long range” transmission can be achieved between the communication device 430 and the server 440 by using WiFi or other wireless long-range communication technologies.

The server 440 is generally a database storing all kinds of media information, such as media signals and codes. Upon receiving the processed server-recognizable code from either the communication device 430 or the signal controlling device 420, the server 440 begins to analyze and match the received code with the reference codes stored in the database. Once the processed code (from outside) and the reference code have been matched, the corresponding media information will be transmitted back to the user on the display unit 450 as shown in FIG. 4a.

In one embodiment, a reverse “short-long” range signal transmission is adapted to transmit the media identification information from the server 440 to the communication device 430 (i.e. long range), and then from the communication device 430 to the signal controlling device 420 (i.e. short range). The media identification information can be shown on the display unit 450, which can be located at the communication device 430, or the signal controlling device 420. In another embodiment, the media identification information can be transmitted from the communication device 430 to the display unit 450 through the antenna 425 and the short range engine 424.

In one embodiment, the identification system 400 can identify a song unknown to the user from the media source 410 such as a radio station. In another embodiment, the identification system 400 can identify a plurality of songs, for example, from an unknown album of a CD. Since the identification system 400 in the present invention converts music segments to music signals to be more efficiently transmitted between the devices and the server 440, the storage capacity of the identification system 400 is substantially enhanced. In an exemplary embodiment, a plurality of songs can be continuously converted to the server-recognizable codes in the signal controlling device 420 and transmitted to the communication device 430, then to the server 440 to obtain music identification information.

Furthermore, since transmitting signals is much faster than transmitting a segment of recorded music, it may not be expensive for the user even if the user uses his mobile phone as the communication device 430. Accordingly, by using the media identification system 400 in the present invention, the user can obtain the music identification information of a plurality of songs more easily, quickly and inexpensively.

The identification system 400 in the present invention can also help the user identify unknown media such as movies. In one embodiment, the server 440 identifies the movie by analyzing and matching the server-recognizable signals converted from some unique information, such as script or music in the movie. The identification system 400 can also be used to identify audio books. For example, the server 440 can identify the audio book by either the name of the chapter or some key words or conversations in the audio book.

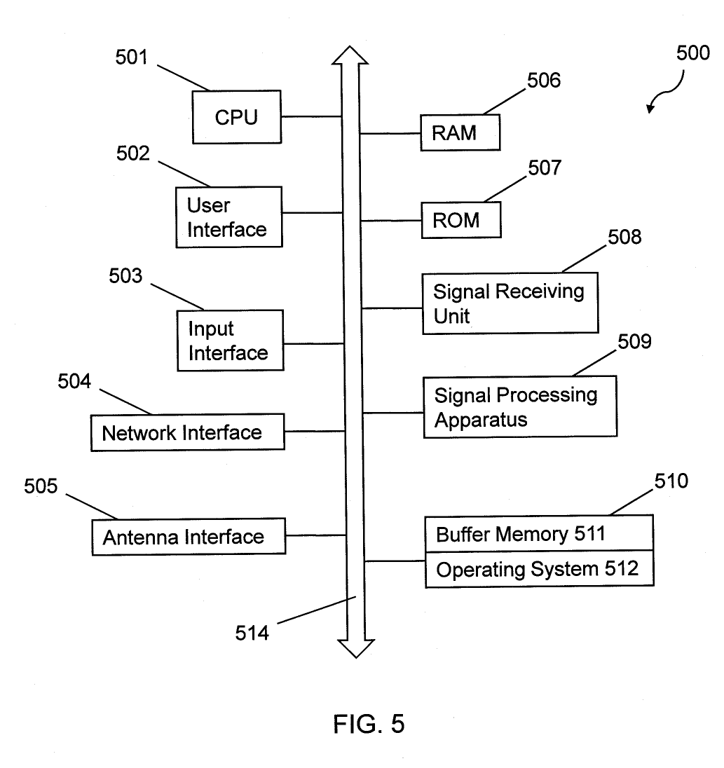

FIG. 5 is a block diagram illustrating an internal architecture 500 of the signal controlling device 420. The architecture 500 includes a central processing unit (CPU) 501 for controlling an overall operation of the signal controlling device 420, a ROM 507 for storing various control programs, a RAM 506 for storing processed results such as server-recognizable media signals in the present invention, and an antenna interface 505. The RAM 506 may also interface with a computer bus 514 so as to provide quick RAM storage to the CPU 501 during the execution of software programs. The antenna interface 505 provides a communication interface with the antenna 425.

The architecture 500 also includes a signal receiving unit 508 adapted to receive media signals from the media source 410, a user interface 502 configured to display media information received from the server 440, and an input interface 503 for the user to input information if necessary. In one embodiment, the user interface 502 includes the display unit 450.

The architecture 500 may also include a signal processing apparatus 509 adapted to create the server-recognizable codes, a network interface 504 and a managing unit 510. The signal processing unit 509 may include the analog-to-digital converter (ADC) 421 and the digital signal processing (DSP) unit 422. As described above, the ADC 421 is configured to convert analog media signals from the media source 410 into digital signals, which will be processed in the DSP unit 422 to generate the server-recognizable code before transmitting to the server 440.

The network interface 504 may include the dialing unit 423 and the short range engine 424 which are communicatively coupled to the antenna 425 to transmit the processed server-recognizable codes to either the communication device or directly to the server 440. The network interface 504 may also include a network connecting module (not shown) adapted to directly transmit the processed server-recognizable code to the server 440. The managing unit 510, which is adapted to control and manage the media identification process, may include a buffer memory 511 for temporary storing data for avoiding data re-processing, and a simplifying operating system 512.

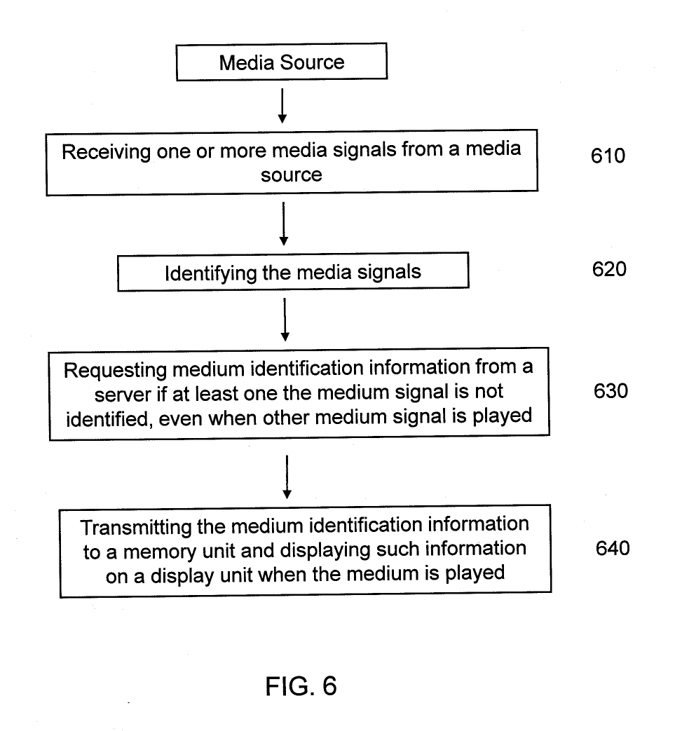

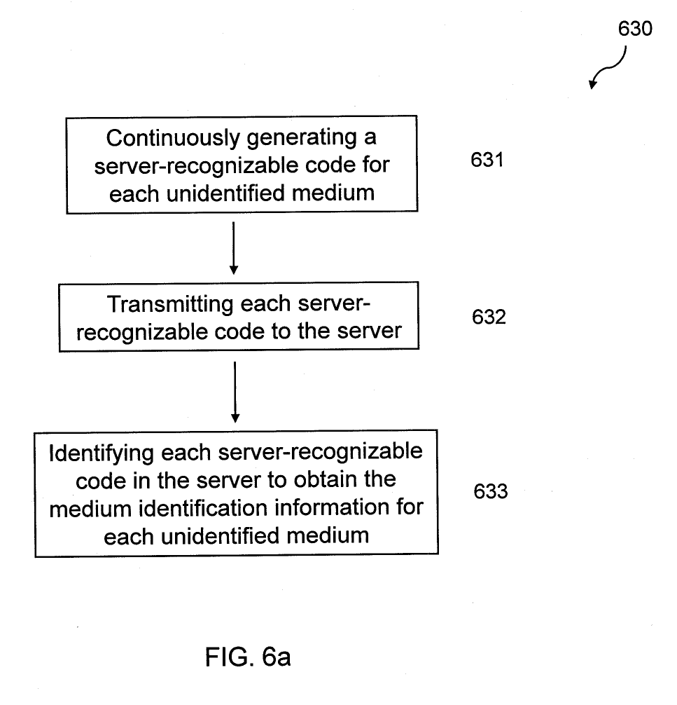

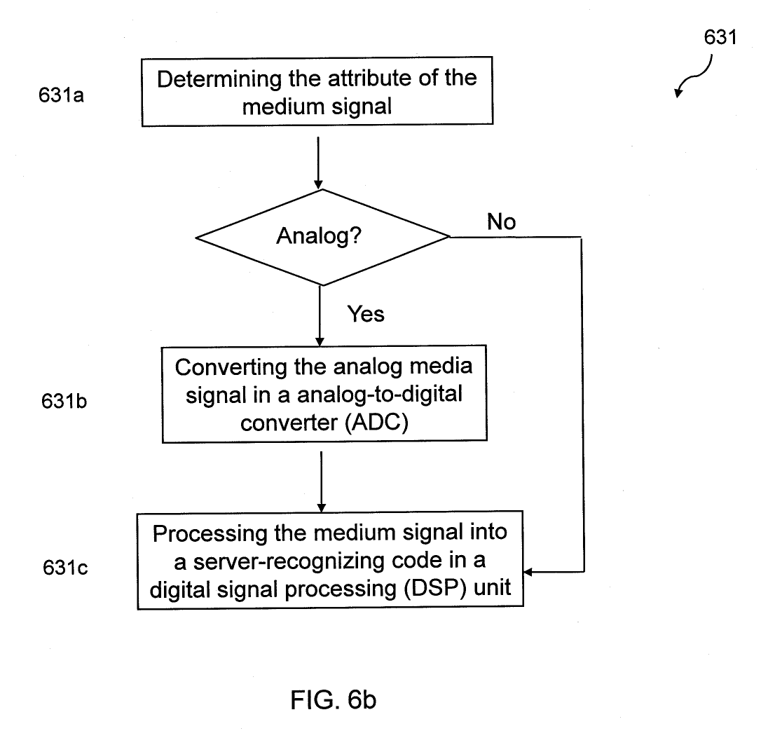

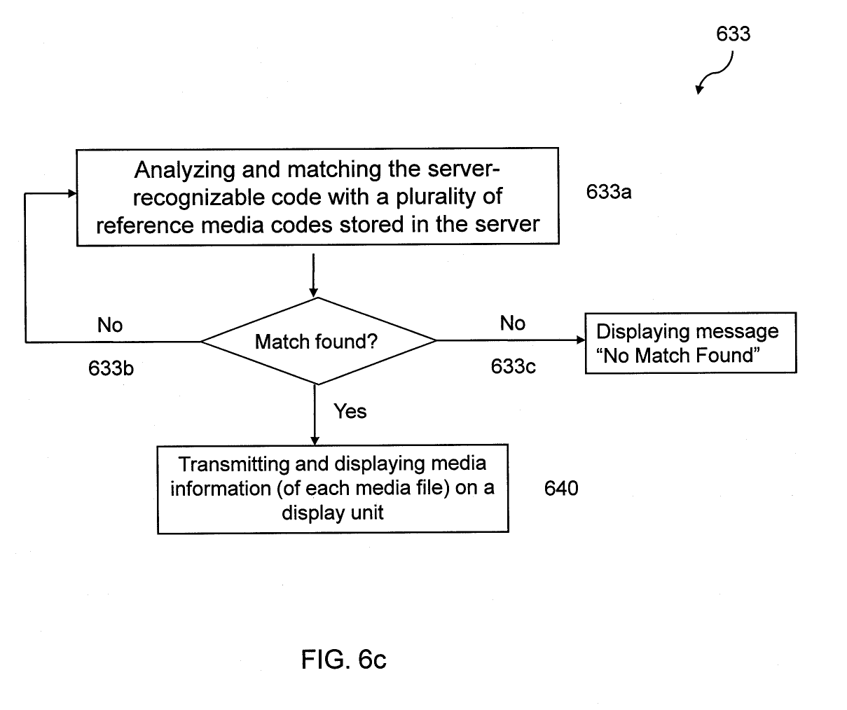

According to another aspect illustrated in FIG. 6, a method for identifying media includes the steps of receiving one or more media signals from a media source 610; identifying the media signals 620; requesting medium identification information from a server if at least one medium signal is not identified, even when other medium is played 630; transmitting the medium identification information to a memory unit and displaying such information on a display unit when the medium is played 640.

In one embodiment as shown in FIG. 6a, the step of requesting identification information of the medium from a server 630 includes the steps of continuously generating a server-recognizable code for each unidentified medium 631; transmitting each server-recognizable code to the server 632; and identifying each server-recognizable code in the server to obtain the medium identification information for each unidentified medium 633.

As can be seen in FIG. 6b, the step of continuously generating a server-recognizable code for each unidentified medium 631 includes the step of determining the attribute of the medium signal 631a. In one embodiment, if the media signal is analog, the step of generating a server-recognizable code for each unidentified medium 631 may also include the step of converting the analog signal to the digital signal in an analog-to-digital converter (ADC) 631b and processing the medium signal to a server-recognizing code in a digital signal processing (DSP) unit 631c. In another embodiment, if the medium signal is digital, the signal can be directly processed in the DSP unit in 631c. In other words, the step 631c is adapted to encode the medium signal into a signal that can be decoded by the server 440.

As shown in step 632, the server-recognizable code is transmitted to the server 440. In one embodiment, the code can be transmitted directly to the server 440. In another embodiment, the code is transmitted via the communication device 430 through a flexible “short-long” range signal transmission process disclosed in the present invention.

Recently, Bluetooth technology becomes popular in short-range wireless communication. Bluetooth is the name for a short-range optical or radio frequency (RF) transmission technology that operates at 2.4 GHz and is capable of transmitting voice and data. The effective range of Bluetooth devices is 32 feet (10 meters). In one embodiment, the communication device 430, e.g. a mobile phone, acts as a bridge to transmit the processed signal from the signal controlling device 420 to the server 440, wherein Bluetooth technology is adapted to transmit the server-recognizable code between the signal controlling device 420 and the communication device 430 (short range), while WiFi or regular wireless mobile phone transmission is adapted to transmit the processed signal from the communication device 430 to the server 440 (long range).

According to one embodiment in the step of identifying each server-recognizable code in the server 633, upon receiving the server-recognizable code from the communication device 430, the server 440 begins the identification process. The step 633 may include the step of analyzing and matching the server-recognizable code with a plurality of reference media codes stored in the server 633a. For example, an identification method developed by Gracenote, creates “fingerprints” for each digital recording to provide the user an easy and convenient platform for media search (The method is exemplified in U.S. Pat. No. 7,328,153, and the contents of which are incorporated herein by reference). In another embodiment, the identification system 400 can provide unknown DVD information by incorporating Gracenote technology (U.S. Pat. No. 6,983,289, and the contents of which are incorporated herein by reference). In a further embodiment, the identification system 400 can provide audio book information by providing either the name of the chapter or some key words or conversations in the audio book to the server 440. If the match is found between the server-recognizable code and the reference code, the media information will be transmitted to the user in step 640. On the other hand, if the match is not found, the system 400 can perform the same search in the server 440 again in step 633b until the match is found. If the match is still not found, a message such as “No Match Found” is transmitted to the user in step 633c. It is noted that other identification systems configured for signal encode-decode can also be utilized.

Finally, in step 640, the media information is transmitted back to the user. In one embodiment, as illustrated above, the media information can be transmitted through reverse “short-long” range signal transmission, meaning that the media information is first transmitted from the server 440 to the communication device 430, then to the display unit 450 located at the signal controlling device 420. In another embodiment, the media information can be transmitted to the display unit 450 on the communication device 430. In still another embodiment, the media information can be transmitted to the display unit on the communication device 430 or the media source 410.

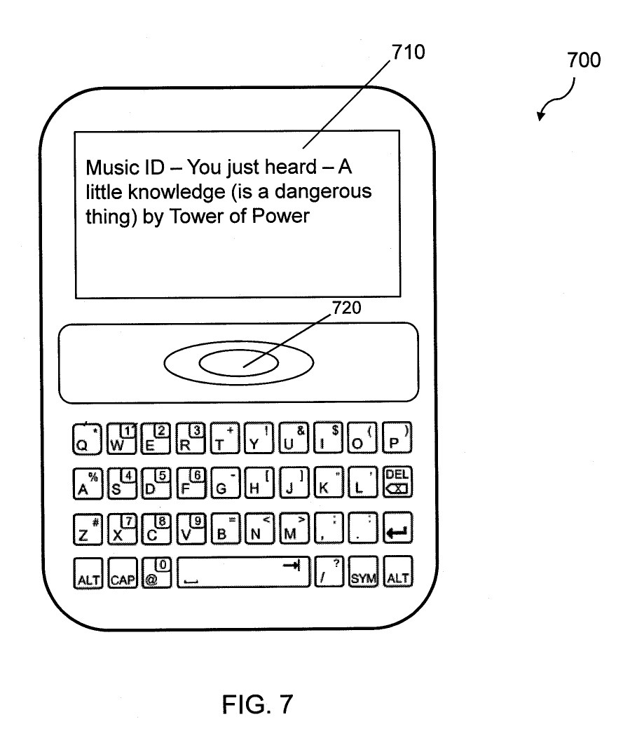

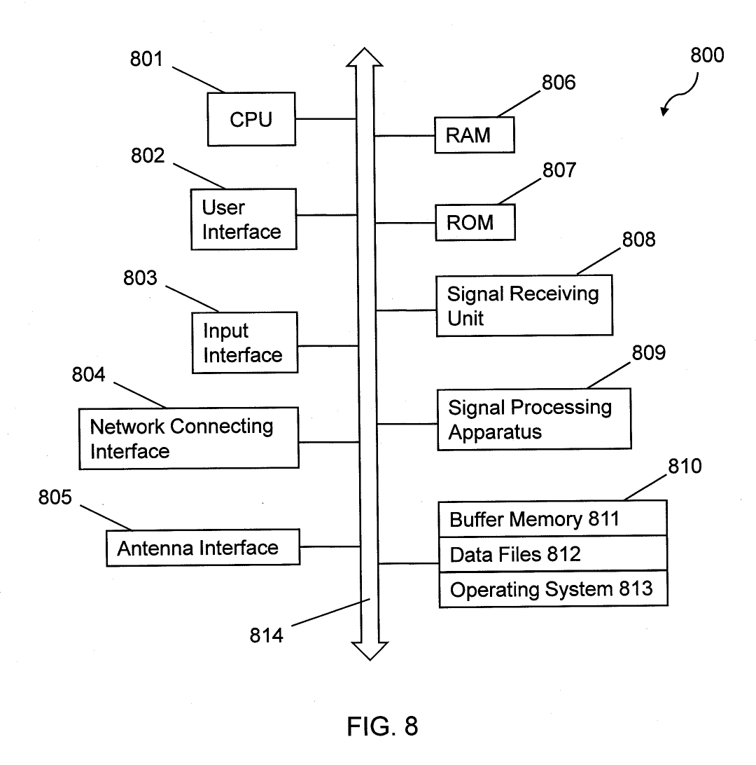

Referring to FIG. 7, a mobile device 700 configured to provide media identification information may include a user interface 710 adapted to display media identification information, and an operation button 720 to act as a “start” button to operate the mobile device 700. FIG. 8 illustrates the mobile device 700's internal architecture 800, which is similar to the internal architecture 500 shown in FIG. 5. For example, the architecture 800 may include a CPU 801, user interface 802, input interface 803, antenna interface 805, RAM 806, ROM 807, signal processing apparatus 809, computer bus 814 and managing unit 810 which includes a buffer memory 811, data files 812 and an operating system 813.

The internal architecture 800 of the mobile device may also include a network connecting interface 804 and a signal receiving unit 808 which may include a media recording unit (not shown) adapted to record at least a portion of the media. For example, the user can record a portion of an unfamiliar song while hearing the song in a store, and the signal processing apparatus 809 is adapted to convert the recorded music to the server-recognizable digital signal as described above.

Unlike the network interface 504, the network connecting interface is adapted to transmit the server-recognizable signals to the server 440, instead of the communication device 430. In one embodiment, the network connecting interface 804 may be integrated with the antenna interface 805 to provide network connection. In another embodiment, the network connecting interface 804 provides a communication interface to a network over the computer network connection, such as WiFi.

Having described the invention by the description and illustrations above, it should be understood that these are exemplary of the invention and are not to be considered as limiting. Accordingly, the invention is not to be considered as limited by the foregoing description, but includes any equivalents.

1. A method for providing media identification information comprises the steps of:
receiving one or more media signals from a media source;
identifying the media signals;
requesting medium identification information from a server if at least one medium signal is not identified, even when other medium is played;
transmitting the medium identification information to a memory unit and displaying such information on a display unit when the medium is played.

2. The method of claim 1, wherein the step of requesting medium identification information from a server comprises the steps of continuously generating a server-recognizable code for each unidentified medium; transmitting each server-recognizable code to the server; and identifying each server-recognizable code in the server to obtain the medium identification information for each unidentified medium.

3. The method of claim 1, wherein the step of continuously generating a server-recognizable code for each unidentified medium comprises the steps of determining the attribute of the medium signal; converting an analog medium signal to a digital medium signal in an analog-to-digital converter (ADC); and processing the digital medium signal to a server-recognizing code in a digital signal processing (DSP) unit.

4. The method of claim 1, wherein the step of transmitting each server-recognizable code to a server further comprises the step of wirelessly transmitting the server-recognizable code to a communication device which is adapted to transmit the server-recognizable code to the server.

5. The method of claim 4, wherein the step of wirelessly transmitting the server-recognizable code to a communication device comprising the step of receiving the server-recognizable code from a short range engine coupled with an antenna.

6. The method of claim 2, wherein the step of identifying each server-recognizable code in the server to obtain the medium identification information for each unidentified medium comprises the step of analyzing and matching the server-recognizable code with a plurality of reference media codes stored in the server.

7. A media identification system comprises:
a media source;
a signal controlling device to continuously receive media signals from the media source and convert the at least a portion of media signals to server-recognizable codes if said portion of media signals are not identified in the signal controlling device;
a server adapted to receive and process said server-recognizable codes and provide media identification information; and
a user interface to display the media identification information provided by the server.

8. The media identification system of claim 7, wherein the signal controlling device comprises an analog-to-digital converter (ADC) and a digital signal processing (DSP) unit to generate said server-recognizable codes.

9. The media identification system of claim 7 further comprises a communication device which is adapted to transmit the server-recognizable codes from the signal controlling device to the server, and reversely transmit the media identification information from the server to the communication device, and further to the user interface.

10. The media identification system of claim 8, wherein the signal controlling device comprises a dialing unit and a short range engine adapted to wirelessly transmit the server-recognizable codes to the communication device, and further to the server.

11. The media identification system of claim 7, wherein the server is configured to analyze and match the server-recognizable codes with a plurality of reference media codes stored in the database to provide the media identification information.

12. The media identification system of claim 7, wherein said media include audio, video and still-frame formats.

13. The media identification system of claim 10, wherein said short range engine is adapted to receive the media identification information from the communication device, and transmit such information to the user interface.

14. A mobile device to provide media identification information comprises:
a signal receiving unit;
a signal controlling device;
a network connecting interface; and
a user interface,
wherein said signal receiving unit obtains media signals from a media source and transmits said media signals to the signal controlling device by continuously converting at least a portion of the media signals to server-recognizable codes if said portion of the media signals are unidentified, said server-recognizable codes are wirelessly transmitted through the network connecting interface to a server and obtain media identification information, which is sent back and displayed on the user interface.

15. The mobile device of claim 14, wherein the signal receiving unit comprises a media recording unit adapted to record at least of a portion of the media.

16. The mobile device of claim 14, wherein the signal controlling device comprises an analog-to-digital converter (ADC) and a digital signal processing (DSP) unit to generate said server-recognizable codes.

17. The mobile device of claim 14, wherein the network connecting interface provides a communication interface over a computer network connection.

18. The mobile device of claim 14, wherein the server is configured to analyze and match the server-recognizable codes with a plurality of reference media codes stored in a database to provide media identification information.

19. The mobile device of claim 14, wherein said media include audio, video and still-frame formats.
